(19) United States
(12) Patent Application Publication
(10) Pub. No.: US 2023/0133722 A1
(43) Pub. Date: May 4, 2023

(54) COLLABORATIVE LEARNING APPLIED TO TRAINING A META-OPTIMIZING FUNCTION TO COMPUTE PARAMETERS FOR DESIGN HOUSE FUNCTIONS

(71) Applicant: HEWLETT PACKARD ENTERPRISE DEVELOPMENT LP, Houston, TX (US)

(72) Inventors: THOMAS VAN VAERENBERGH, Diegem (BE); PENG SUN, Milpitas, CA (US); MARTIN FOLTIN, Ft. Collins, CO (US); RAYMOND G. BEAUSOLEIL, Milpitas, CA (US)

(21) Appl. No.: 17/515,368

(22) Filed: Oct. 29, 2021

(51) Int. Cl. G06N 20/20; G06F 17/18

(52) U.S. Cl. CPC G06N 20/20; G06F 17/18

(57) ABSTRACT

Systems and methods are provided for creating and sharing knowledge among design houses. In particular, examples of the presently disclosed technology leverage the concepts of meta-optimizing and collaborative learning to reduce the computational burden shouldered by individual design houses using inverse design techniques to find optimal designs in a manner which protects intellectual property sensitive information. Examples may share versions of a central meta-optimizer (i.e. local meta-optimizers) among design houses targeting different (but related) design tasks. A local meta-optimizer can be trained to indirectly optimize a design task by computing hyper-parameters for a design house's private optimization function. The private optimization function may be using inverse design techniques to find an optimal design for a design task. This may correspond to finding a global minimum of a cost function using gradient descent techniques or more advanced global optimization techniques.

### BACKGROUND

Inverse design is a backwards type of optimization problem which starts with a desired performance goal, and finds an optimal design which achieves the performance goal. For example, a design house (e.g. a photonic design house) may specify a desired performance goal (e.g. a certain bandwidth or insertion loss) for a particular design task (e.g. designing a grating coupler). The design house may use inverse design techniques (such as gradient descent using the adjoint method) to find an optimal design which achieves the performance goal.

Meta-optimizing (also known as meta-learning) is the use of one optimization method/function to tune another optimization method/function. For example, a meta-optimizing function may be trained to tune the parameters of another optimization function.

Collaborative learning (such as federated learning or swarm learning) involves two or more entities (e.g. people, machines, machine learning models, etc.) attempting to learn something together. For example, collaborative learning may involve methodologies where learners engage in a similar task, and create and share knowledge with each other.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1 illustrates an example cost function which a design house's private optimization function may seek to minimize

FIG. 2 illustrates an example architecture for collaborative optimization, in accordance with examples of the presently disclosed technology.

FIG. 3 illustrates a sequential learning approach by which two or more design houses may create and share knowledge, in accordance with various examples of the presently disclosed technology.

FIG. 4 illustrates a federated learning approach by which two or more design houses may create and share knowledge, in accordance with various examples of the presently disclosed technology.

FIG. 5 illustrates a swarm learning approach by which two or more design houses may create and share knowledge, in accordance with various examples of the presently disclosed technology.

FIG. 6 illustrates an example computing component that may be used to implement a collaborative learning approach by which one or more design houses may create and share knowledge in accordance with various examples.

FIG. 7 illustrates another example computing component that may be used to implement a collaborative learning approach by which one or more design houses may create and share knowledge in accordance with various examples.

FIG. 8 illustrates an example computing component that may be used to implement a swarm learning approach by which one or more design houses may create and share knowledge in accordance with various examples.

FIG. 9 is an example computing component that may be used to implement various features of examples described in the present disclosure.

The figures are not exhaustive and do not limit the present disclosure to the precise form disclosed.

### DETAILED DESCRIPTION

As described above, inverse design is a backwards type of optimization problem which starts with a desired performance goal, and determines an optimal design which achieves the performance goal (the terms “optimize,” “optimal” and the like as used herein can be used to mean making or achieving performance as effective or perfect as possible). In some cases, the optimal design may correspond to a global minimum of a cost function and certain sub-optimal designs may correspond to local minima of the cost function. A challenge with inverse design is that in many cases, finding the global minimum (as opposed to one of a potentially many local minima) requires running a vast number of field simulations. Accordingly, inverse design techniques (such as gradient descent using the adjoint method) may be extremely computationally intensive for the design houses which employ them.

Against this backdrop, examples of the presently disclosed technology leverage the concepts of meta-optimizing and collaborative learning to reduce the computational burden shouldered by individual design houses using inverse design techniques to find optimal designs. This reduction in computational burden may correspond to reducing the number of field simulations that a design house (e.g. a photonics design house or an analog integrated circuit design house) runs to find an optimal design (e.g. an optimal design for a grating coupler or an analog integrated circuit).

Examples may share versions of a central meta-optimizer (i.e. local meta-optimizers) among design houses targeting different (but related) design tasks. A local meta-optimizer can be trained to indirectly optimize a design task by computing hyper-parameters for a design house's private optimization function. The private optimization function may be using inverse design techniques to find an optimal design for a design task. As described above, this may correspond to finding the global minimum of a cost function using gradient descent techniques.

In some examples, a central broker may receive information associated with the training of one or more local meta-optimizers. For example, the central broker may receive any one, or combination of (a) the parameters of the local meta-optimizers, (b) information related to the design tasks assigned to private optimization functions, and (c) information associated with the performance of the local meta-optimizer-private optimization function combinations (e.g. the number of field simulations required to find a global minimum). Based on this information, the central broker may determine to modify parameters of the central meta-optimizer in a manner which improves/optimizes the performance of the local meta optimizer-private optimization function combinations (e.g. reducing the number of simulations required to find the global minimum/optimal design). Accordingly, versions of this modified central meta-optimizer (i.e. new/improved local meta-optimizers) may be distributed to design houses for future training sets. In this way, examples of the presently disclosed technology may create and share knowledge which improves the efficiency and effectiveness of participating design houses' private optimization functions. This in turn may reduce the number of field simulations required to find optimal designs. Put another way, the computational burden shouldered by participating design houses may be reduced.

By their unique architecture, examples of the presently disclosed technology create and share knowledge in a manner which protects the proprietary information/data of participating design houses. In part, this is accomplished by leveraging the concept of meta-optimization to tailor conventional collaborative learning approaches to an intellectual property (IP) sensitive application.

For example, using one conventional collaborative learning approach, knowledge could be shared among competing design houses by having design houses share optimal designs they have found. However, because these optimal designs have tremendous proprietary value to each design house, this approach would not be commercially feasible. Another conventional collaborative learning approach could involve design houses sharing the parameters of their private optimization functions. However, these private optimization functions have significant proprietary value to each design house as well. Accordingly, collaborative learning by this approach would not be commercially feasible.

Using another collaborative learning approach, local versions of a central model (e.g. a central optimization function) could be distributed among several design houses. The local versions of the model could then be trained to optimize design house specific tasks. Accordingly, a broker of the central model could receive information associated with the local trainings (e.g. the parameters of the local versions of the central model), and update parameters of the central model accordingly. A first flaw in this approach is that a participating design house's proprietary information (e.g. full field simulation data, device/circuit/network parameters, obtained gradients and Hessians of the device/circuit/network parameters, etc.) could be indirectly exposed as the shared model would be trained directly on the design house's data/tasks. Another flaw in this approach is that because local versions of the model are learning to optimize different design tasks, the knowledge they acquire may not be transferable to other design tasks.

By contrast, examples of the presently disclosed technology insulate a design house's proprietary data by sharing versions of a meta-optimizer (as opposed to a primary optimizer). As described above, a local meta-optimizer may be trained to tune/optimize the hyper-parameters of a design house's private optimization function. Put another way, the local meta-optimizer is one optimization function removed from the design house's sensitive proprietary data. Thus, the performance of the private optimization function may be improved while the design house's proprietary data and private optimization parameters remain insulated from competing design houses. Similarly, because the local meta-optimizer is one level of abstraction above specific design tasks, training knowledge may be more transferable than if the local meta-optimizers were being trained directly on design tasks.

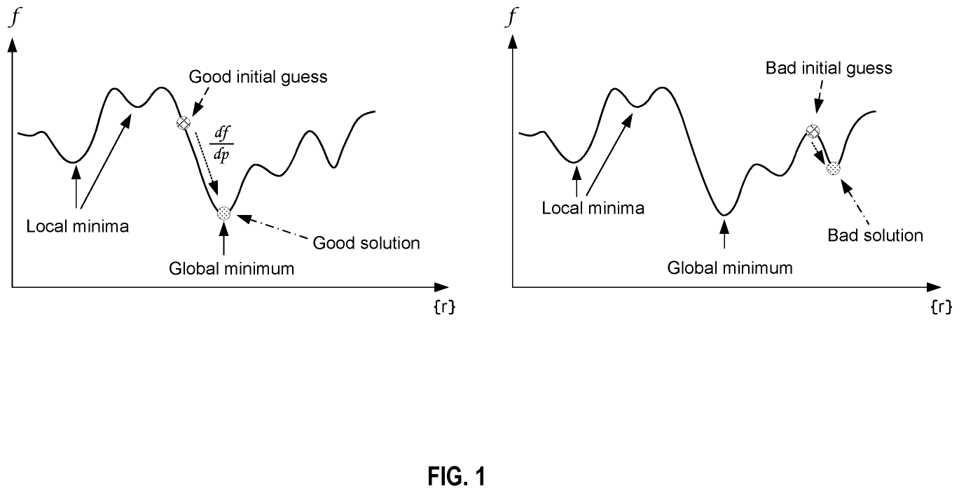

FIG. 1 illustrates an example cost function which a design house's private optimization function may seek to minimize (i.e. seek to find the global minimum of). As described above, the global minimum of the cost function may correspond to an optimal design for a particular design task. Put another way, given particular physical constraints and a desired performance goal, a private optimization function may use inverse design techniques to find the global minimum of a cost function like this. That global minimum may correspond to an optimal design for the given constraints and desired performance goal.

As used herein, a private optimization function may be a computer model or algorithm (e.g. a machine learning model/algorithm) that a design house trains to complete design tasks. Accordingly, a design house (e.g. a photonics design house or an analog integrated circuit design house) may be any individual or entity which trains a private optimization function to complete design tasks.

A design task may be any undertaking of work that has a goal of finding an optimal design. For example, a design task may involve running field simulations and performing optimization techniques (e.g. gradient descent techniques) in order to find an optimal design for a device, a circuit, or a network. Accordingly, a design task may be completed when an optimal design is found. In certain examples, a design task may be subject to one or more physical constraints (e.g. the limitations of a design house's foundry platform, laws of physics, etc.). In some examples, a design task may also have a desired performance goal (e.g. a certain bandwidth or insertion loss).

An optimal (or optimized) design may be a design/geometry which achieves performance as effective or perfect as possible. However, as one of ordinary skill in the art will recognize, perfection cannot always be achieved. Accordingly, an optimal design can also encompass a design/geometry which achieves performance as good or effective as possible or practical given certain physical constraints. An optimal design may also be a design/geometry which achieves a desired performance goal as effective or closely as possible.

For example, a photonic design house may be seeking to find an optimal design for a grating coupler. This design task may have particular physical constraints. For example, the fabrication process may require a base silicon wafer of thickness 270 nm, with a buried oxide layer of thickness 2 um. The fabrication process may also have a minimum feature size. Additionally, the single mode optical fiber at the wavelength of interest to the design house may have a core diameter of 9.2 um (for 1310 nm). Given these constraints (along with laws of physics), the design house may specify a desired performance goal (e.g. an insertion loss at the wavelength of interest under 1 dB). With the physical constraints described above as inputs, the private optimization function may be used to find an optimal grating coupler design which achieves the desired performance goal.

As described above, an optimal design may correspond to the global minimum of a cost function. A design house's private optimization function may be trained to find this global minimum by running simulations (e.g. electromagnetic field simulations) and applying techniques such as gradient descent. Gradient descent is a first-order iterative optimization technique which can be used to find minima of a differentiable function. The idea is to take repeated steps in the opposite direction of the gradient of the function at given point, as this is the direction of steepest descent. However, many cost functions (such as the example cost function illustrated in FIG. 1) have numerous local minima which correspond to sub-optimal designs. A challenge with gradient decent (and more generally inverse design) is avoiding these local minima. This may be achieved by running a vast number of field simulations where different initial conditions are sampled. This can be extremely computationally intensive. In some cases, a design house may not have the resources (e.g. financial and data resources) to run these field simulations.

However, examples of the presently disclosed technology leverage the concepts of meta-optimizing and collaborative learning to reduce the number of simulations required to find the global minimum/optimal design. These results are achieved in a manner which insulates the valuable proprietary information of each design house. (e.g. full field simulation data, device/circuit/network parameters, obtained gradients and Hessians of the device/circuit/network parameters, etc.).

In certain cases finding local minima which are close approximations of the global minimum can be an acceptable outcome for a design house. In these cases, the local minima may correspond to slightly different designs, which have the same/similar performance as the optimal design (which corresponds to the global minimum). Accordingly, in certain cases a private optimization function may not find the global minimum of a cost function, but one of these local minima which closely approximate the global minimum.

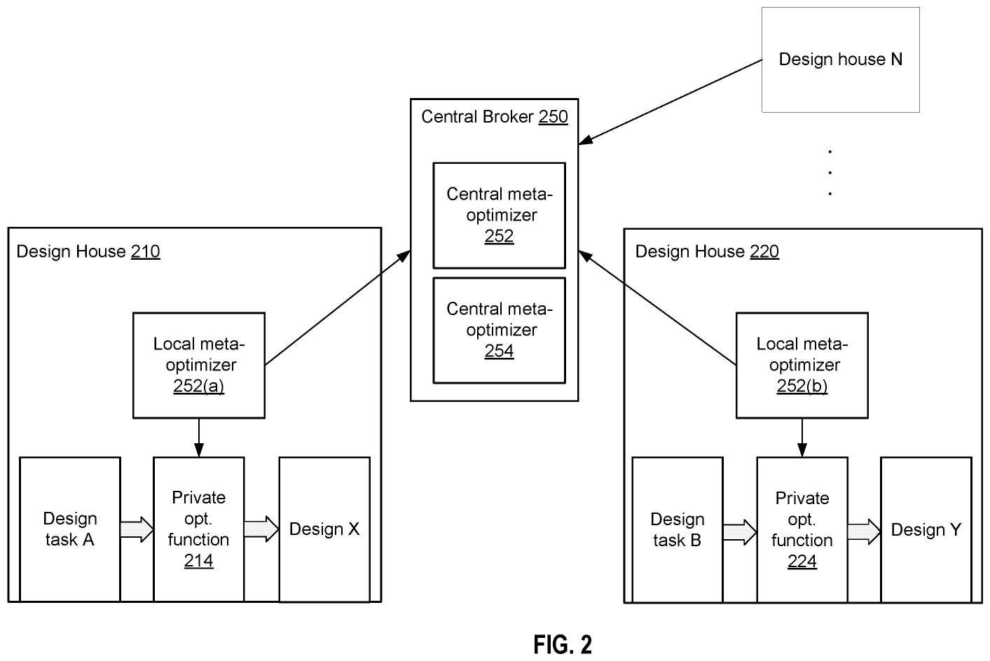

FIG. 2 illustrates an example architecture for collaborative optimization, in accordance with examples of the presently disclosed technology.

Design Houses: As described above, a design house may be any individual or entity which trains a private optimization function to complete design tasks. The example architecture depicts two design houses, design house 210 and 220. This architecture may be extended to any number of design houses. These design houses may occupy a variety of fields, e.g., photonic device design, analog circuit design, computer network design, etc.

Design Tasks: A design task may be any undertaking of work that has a goal of finding an optimal design. For example, a design task may involve running field simulations and performing optimization techniques (e.g. gradient descent techniques) in order to find an optimal design for a device, a circuit, or a network. Accordingly, a design task may be completed when an optimal design is found. In certain examples, a design task may be subject to one or more physical constraints (e.g. the limitations of a design house's foundry platform, laws of physics, etc.). In some examples, a design task may also have a desired performance goal (e.g. a certain bandwidth or insertion loss).

In various examples, different design houses may be performing different, but related design tasks. For example, design house 210 may be seeking to find an optimal design for a grating coupler at 8° C. for a desired performance goal. Design house 220 may be seeking to find an optimal design for a grating coupler at 0° C. with a different performance goal. The two design houses may be using different foundry platforms, and may be constrained by different physical limitations (e.g. different minimum feature sizes, different base silicon thicknesses, etc.). However, the power of the presently disclosed technology lies in its ability to generalize the knowledge acquired while performing a design task at one design house, and intelligently apply it to different design tasks being performed at a different design houses.

In another example, design house 210 may be seeking to find an optimal design for a grating coupler device, and design house 220 may be seeking to find an optimal design for a Bragg grating. Although these are different types of devices, they both rely on similar physics (specifically they are both based on periodicity). Accordingly, design houses may benefit from shared knowledge of how the local meta-optimizers deployed at their respective sites learned to tune private optimization functions tasked with finding optimal designs for devices which rely on periodicity. Put another way, through meta-optimization and collaborative learning, knowledge gained while optimizing a first design task, may be leveraged in order to better optimize a second design task.

Private Optimization Functions: As described above, a private optimization function may be a computer model or algorithm (e.g. a machine learning model/algorithm) that a design house uses/trains to find optimal designs. Accordingly, design houses 210 and 220 may use their own private optimization functions (e.g. private optimization functions 214 and 224 respectively) to find optimal designs for their design tasks. As described in FIG. 1, these optimal designs may correspond to global minima of cost functions. Private optimization functions 214 and 224 may be trained to find these global minima by running field simulations, and performing techniques such as gradient descent or reinforcement learning.

A private optimization function may have regular parameters and hyper-parameters. The regular parameters of the private optimization function may be modified by the private optimization function as it learns. For example, using any number of machine learning techniques (e.g. reinforcement learning), a private optimization function may learn that under certain of its parameterizations, the number of field simulations it requires to find an optimal design/global minimum is reduced. The private optimization function may modify its parameters in accordance with this learning.

By contrast, the hyper-parameters of a private optimization function are not modified by the private optimization function as it learns. Instead, these hyper-parameters are set by an outside source. This outside source may be the creator of the private optimization function (e.g. a design house engineer), or in accordance with examples of the presently disclosed technology, a local meta-optimizer.

Like the selection/modification of its regular parameters, the selection/modification of the private optimization function's hyper-parameters influence its performance. Accordingly, each local meta-optimizer may learn to set/modify the hyper-parameters of its associated private optimization function in a manner which improves/optimizes the performance of the private optimization function. As described above, this may correspond to reducing the number of field simulations that the private optimization function needs to run in order to find the global minimum of a cost function (i.e. to find an optimal design).

Local Meta-Optimizers: A meta-optimizer may be a computer model or algorithm (e.g. a machine learning model/algorithm) which is used/trained to improve or optimize the performance of an optimization function (e.g. private optimization function 214 or 224).

A local meta-optimizer is a meta-optimizer which is a version of a central meta-optimizer (which is also a meta-optimizer). For example, local meta-optimizers 252a and 252b (deployed at design house 210 and 220 respectively) may be exact copies, or modified versions, of central meta-optimizer 252.

Once deployed, a local meta-optimizer may be trained to improve/optimize the performance of its associated private optimization function (i.e. the private optimization function “beneath it”). In some examples, this may correspond to being trained to tune the hyper-parameters of the private optimization function in a manner which reduces the number of field simulations the private optimization function requires to find an optimal design.

In some examples, a local meta-optimizer may be trained by completing one or more training sets. A training set may correspond to the performance of one or more design tasks by the private optimization function. As described above, each design task may be completed when an optimal design is found by the private optimization function (in some cases, this will be an optimal design which achieves a desired performance goal). This may involve running thousands (or even millions) of field simulations, and performing inverse design techniques such as gradient descent or more advanced techniques. As will be described below, information associated with these training sets may be provided to central broker 250. This information may include any one, or combination of: (1) the parameters of a local meta-optimizer (like each private optimization function, a local meta-optimizer may modify its own parameters as it trains/learns); (2) information related to the design task(s) a private optimization function is seeking to optimize; and (3) information associated with the performance of a local meta-optimizer-private optimization function combination.

Parameters of the local meta-optimizer may include weights, gradients (which may implicitly demonstrate performance of the local meta-optimizer), and biases of the local meta-optimizer. As described above, machine learning models may modify their own parameters as they learn. Accordingly, as a local meta-optimizer learns to tune the hyper-parameters of the private optimization function beneath it, it may modify its own parameters. For example, as a local meta-optimizer-private optimization function combination completes design tasks, the local meta-optimizer may learn that certain of its parameterizations tend to improve/optimize the performance of the private optimization beneath it. Put another way, the local meta-optimizer may learn that certain of its own parameterizations tend to tune the hyper-parameters of the private optimization function beneath it in a manner which improves/optimizes the performance of the private optimization function (as described above, improving/optimizing the performance of the private optimization function may correspond to reducing the number of field simulations the private optimization functions requires to find an optimal design). The local meta-optimizer may then modify its own parameters in accordance with this learning.

As used herein, a local meta-optimizer-private optimization function combination may jointly refer to a private optimization function and the local meta-optimizer which is tuning the private optimization function's hyper-parameters. Accordingly, the performance of a local meta-optimizer-private optimization function combination may refer to the performance of the “tuned” private optimization function when completing a design task/training set.

Central Broker and Central Meta-Optimizers: The central broker may be an individual or entity (e.g. a computer program, a machine learning model, etc.) which manages the distribution of local meta-optimizers to design houses. The central broker may also manage the parameters of one or more central meta-optimizers. In some examples, this may involve updating/modifying the parameters of a central meta-optimizer in accordance with the parameters of one or more of its associated local meta-optimizers. For example, as will be described below, central broker 250 may determine to update the parameters of central meta-optimizer 252 in accordance with the parameters of local meta-optimizers 252a and/or 252b.

As illustrated, central broker 250 manages two central meta-optimizers (central meta-optimizers 252 and 254). However, central broker 250 may manage any number of central meta-optimizers. As described above, a meta-optimizer (such as central meta-optimizers 252 and 254) may be a computer model or algorithm (e.g. a machine learning model/algorithm) which is used/trained to improve/optimize the performance of another optimization function.

In some examples, a central-meta optimizer may have its own application space. This application space may define the type of design tasks/design fields that the central meta-optimizer is suited to optimize. For example, the application space for central meta-optimizer 252 may be photonic circuit designs which utilize a particular foundry. By contrast, the application space for central meta-optimizer 254 may be broader. For example, its application space may comprise photonic circuit design, regardless of foundry. In another example, its application space may include a particular type of device design, or a particular type of network design.

In certain examples, central broker 250 may manage multiple central meta-optimizers which have different prices/costs. For example, central meta-optimizer 252 may be a “premium” meta-optimizer which design houses have to pay to use. By contrast, central meta-optimizer 254 may be an “economy” meta-optimizer which is freely available.

As described above, the central broker may manage the distribution of versions of different central meta-optimizers (i.e. the local meta-optimizers) to various design houses. Here, local meta-optimizers 252a and 252b are versions of central meta-optimizer 252. In some examples, they may be exact copies of the most up-to-date version of central meta-optimizer 252. In other examples they may be modified versions of central meta-optimizer 252. For example, central broker 250 may learn that a recent update to the parameters of central optimizer 252 tends to (1) reduce the number of field simulations required to find an optimal design for a grating coupler, and (2) increase the number of field simulations required to find an optimal design for a Bragg grating. Accordingly, if design house 210 is designing a grating coupler, and design house 212 is designing a Bragg grating, central broker 250 may decide to distribute a current version of central meta-optimizer 252 to design house 210, and a prior version of central meta-optimizer 252 to design house 220.

Similarly, the central broker may select an appropriate central meta-optimizer for a design house based on the design task the design house is targeting. For example, design house 210 may be designing a grating coupler. The application space of central meta-optimizer 252 may include grating coupler design, whereas the application space of central meta-optimizer 254 may not. Accordingly, central broker 250 may decide to distribute a version of central meta-optimizer 252 (e.g. local meta-optimizer 252a) to design house 210.

Based on information it receives associated with the training of local meta-optimizers, the central broker may determine to update/modify the parameters of the central meta-optimizers. This received information may include any one, or combination of: (1) parameters of a local meta-optimizer; (2) information related to the design task(s) a private optimization function is seeking to optimize; and (3) information associated with the performance of a local meta-optimizer-private optimization function combination.

As described above, parameters of a local meta-optimizer may refer to the parameters of a local meta-optimizer which has begun at least one training set. These parameters may include any updates/modifications that the local meta-optimizer has made to its own parameters in response to training. As described above, the parameters of a local meta-optimizer may be part of the information received by the central broker.

Information related to design tasks may include design field (e.g. photonics vs. electronics), design type (e.g. device vs. circuit vs. network) and certain design constraints (e.g. platform thickness and geometry, number of layers, wavelength choice, minimum feature size, etc.). This information may also include information associated with the adequacy of the field simulations performed by the design house. For example, design house 210 may have performed 70 forward field simulations and 65 backwards adjoint simulations for a particular design task. This may be emblematic of an adequate simulation known/expected to produce useful training data. By contrast, design house 220 may have performed 30 field forward simulations and 30 backwards adjoint simulations for a particular design task, which may be emblematic of an inadequate simulation known/expected to produce unreliable training data. As will be described below, central broker 250 may consider the adequacy of the simulations performed by a design house in determining whether to modify parameters of a central meta-optimizer in accordance with training information received from that design house.

Information associated with the performance of the local meta-optimizer-private optimization function combination may include any one or combination of the number of field simulations, the amount of time, and the amount of computing effort required to find an optimal design. This information may also include whether the found design achieved a desired performance goal, and if not, the magnitude of deviation. In examples where the private optimization function is being trained using reinforcement learning, the cumulative reward obtained by the private optimization function upon completion of a design task may be provided as well. (As used herein, reinforcement learning may refer to a machine learning technique which teaches an agent, such as a private optimization function, to find an optimal policy. This may be a policy which reduces the number of field simulations required to find the global minimum of a cost function/optimal design. As part of reinforcement learning, the agent/private optimization function may receive quantitative rewards and punishments for performing certain actions. The summation of these quantitative rewards and punishments may be referred to as a cumulative reward. Accordingly, an optimal policy may be a policy which maximizes this cumulative reward).

Based on the training information that it receives, the central broker may determine to modify the parameters of a central meta-optimizer. For example, central broker 250 may determine to modify the parameters of central meta-optimizer 252 in accordance with either or both of the parameters of local meta-optimizers 252a and 252b. Central broker 250 may consider a number of factors in making this determination.

In some examples, the central broker may consider whether the design task that a local meta-optimizer was trained on fits the application space of the central meta-optimizer. For example, if the application space for central meta-optimizer 252 is photonic circuit design using a particular foundry type, and the design task targeted by design house 220 involved photonic circuit design using a different foundry type, central broker 250 may decide not to modify the parameters of central meta-optimizer 252 in accordance with the parameters of local meta-optimizer 252b. However, abstraction may be a feature of the presently disclosed technology. Accordingly, in some examples, central broker 250 may determine to modify parameters of a central meta-optimizer in accordance with training that deviates somewhat from the central meta-optimizer's specific application space.

As described above, the central broker may also consider the adequacy of training/simulations performed at a design house when determining whether or not to update the parameters of a central meta-optimizer. For example, if design house 220 did not perform any backwards adjoint type simulations, central broker 250 may identify local meta-optimizer 252b's training as unreliable. Accordingly, central broker 250 may determine not to update central meta-optimizer 252 in accordance with the parameters of local meta-optimizer 252b.

The central broker may also consider the performance of the local meta-optimizer-private optimization combination when determining whether or not to update the parameters of a central meta-optimizer. Performance may be measured in myriad ways. As examples, the central broker may consider (1) the amount of time/computing power/simulations required to complete a design task; (2) improvements in the amount of time/computing power/simulations required to complete successive similar design tasks; (3) whether the completed design task achieved a desired performance goal; and (4) where a private optimization function is being trained using reinforcement learning, the cumulative reward obtained by the private optimization function upon completion of one or more design tasks.

For example, central broker 250 may receive information indicating that the local meta-optimizer 252a-private optimization function 214 combination reduced the time required to complete a design task four consecutive times. By contrast, the local meta-optimizer 252b-private optimization function 224 combination may have shown no improvement upon completing four consecutive design tasks. Accordingly, central broker 250 may determine to update the parameters of central meta-optimizer 252 in accordance with local meta-optimizer 252a's parameters, but not 252b's.

In an example where reinforcement learning is being used to train the private optimization functions, central broker 250 may receive information indicating that private optimization function 214 obtained a cumulative reward which exceeded a threshold value for its most recent training set/design task, and private optimization function 224 obtained a cumulative reward less than the threshold value for its most recent training set/design task. Accordingly, central broker 250 may determine to update the parameters of central meta-optimizer 252 in accordance with the parameters of local meta-optimizer 252a only.

Once the central broker has updated the parameters of a central meta-optimizer, versions of the modified/improved central meta-optimizer may be distributed to design houses for future training sets. These modified/improved versions of the central meta-optimizer may be more effective at improving/optimizing the private optimization functions beneath them than previous versions. In this way, examples of the presently disclosed technology may create and share knowledge in a manner that improves the efficiency and effectiveness of a participating design house's private optimization function. This in turn may reduce the amount of time/amount of computing power/number of field simulations required by the design house to find an optimal design using inverse design techniques.

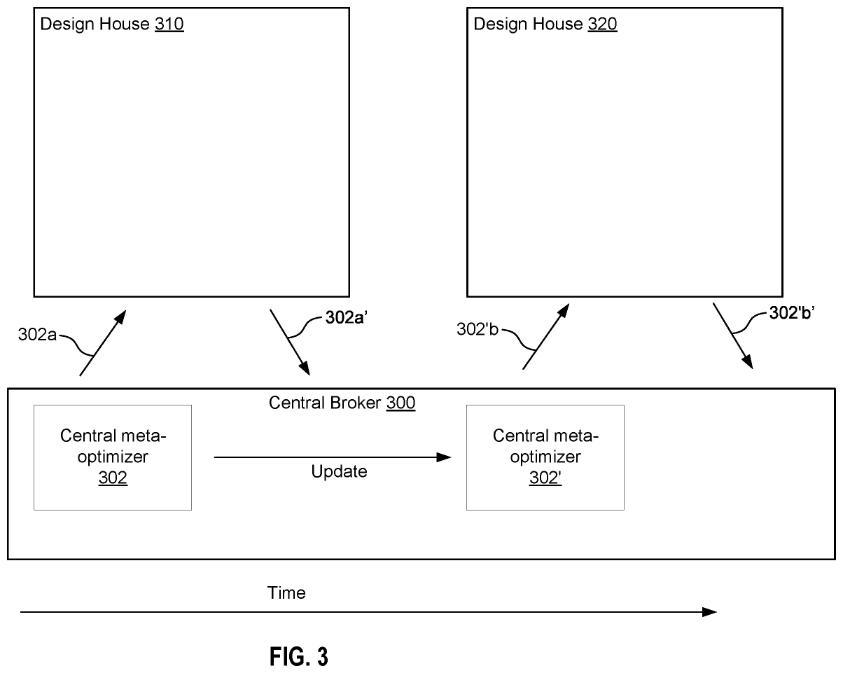

FIG. 3 illustrates a sequential learning approach by which two or more design houses may create and share knowledge, in accordance with various examples of the presently disclosed technology. Here, sequential learning is one example approach under the more general collaborative learning umbrella.

Similar to FIG. 2, FIG. 3 depicts two design houses (design houses 310 and 320) and a central broker 300. Here, central broker 300 manages the parameters and distribution (in the form of local meta-optimizers) of central meta-optimizer 302. This collaborative learning approach may be extended to any number of design houses. Similarly, in various examples central broker 300 may manage any number of central meta-optimizers.

As an initial step, central broker 300 provides local meta-optimizer 302a to design house 310. Local meta-optimizer may be a version of central meta-optimizer 302. As described above, local meta-optimizer 302a may be an exact copy of central meta-optimizer 302, or a modified version.

Upon receipt of local meta-optimizer 302a, design house 310 may train local meta-optimizer 302a to compute hyper-parameters for a private optimization function. As described in conjunction with FIG. 2, the private optimization function may be tasked with finding an optimal design for a particular design task.

In some examples, local meta-optimizer 302a may be trained by completing one or more training sets. A training set may correspond to the performance of one or more design tasks by design house 310's private optimization function. As described above, a design task may be completed when an optimal is found by the private optimization function (in some cases, this will be an optimal which achieves a desired performance goal).

Upon completion of one or more training sets, design house 310 may provide information associated with the training of local meta-optimizer 302a to central broker 300. This information may include the newly trained parameters of local meta-optimizer 302a, which are represented as trained parameters 302a′. Information associated with (a) the design task(s) being targeted during the training, and (b) the performance of local meta-optimizer 302a and the private optimization function beneath it may also be provided.

At the next step, central broker 300 determines whether or not to update the parameters of central meta-optimizer 302 in accordance with trained parameters 302a′. Central broker 300 may consider a number of factors in making this determination. For example, central broker may consider (1) whether a design task fits the application space of central meta-optimizer 302; (2) the adequacy of training/simulations performed by design house 310; (3) the performance of local meta-optimizer 302a and the private optimization function beneath it; and (4) whether the performance of central meta-optimizer 302 has converged.

Upon determining to update the parameters of central meta-optimizer 302 (the updated version of which may now be represented as central meta-optimizer 302′), the process may be repeated for design house 320. In particular, central broker 300 may provide a version of central meta-optimizer 302′ (i.e. local meta-optimizer 302′a) to design house 320. Design house 320 may train local meta-optimizer 302′a in a similar fashion as described above. Accordingly, design house 320 may provide the trained parameters of local meta-optimizer 302′a (i.e. trained parameters 302′a′) to central broker 300. Central broker 300 may then determine whether or not to modify the parameters of central meta-optimizer 302′ in accordance with trained parameters 302′a′.

With each iteration of the process described above, central meta-optimizer 302 may be refined in a manner which improves its performance. In particular, it may be refined to better improve/optimize the performance of private optimization functions. In this way, a participating design house benefits from previous trainings performed at other design houses.

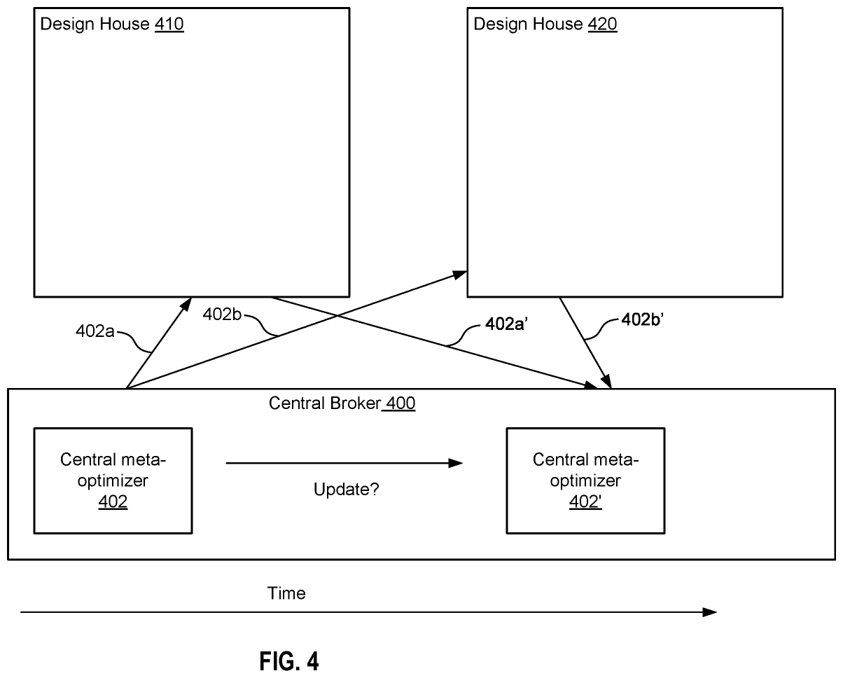

FIG. 4 illustrates a federated learning approach by which two or more design houses may create and share knowledge, in accordance with various examples of the presently disclosed technology. Here, federated learning is one example approach under the more general collaborative learning umbrella.

Similar to FIG. 3, FIG. 4 depicts two design houses (design houses 410 and 420) and a central broker 400. Here, central broker 400 manages parameters and distribution (in the form of local meta-optimizers) of central meta-optimizer 402. This collaborative learning approach may be extended to any number of design houses. Similarly, in various examples central broker 400 may manage any number of central meta-optimizers.

As an initial step, central broker 400 provides local meta-optimizer 402a to design house 410 and local meta-optimizer 402b to design house 420. Local meta-optimizers 402a and 402b may be versions of central meta-optimizer 402. As described above, local meta-optimizers 402a and 402b may be exact copies of central meta-optimizer 402, or modified versions. Accordingly, local meta-optimizers 402a and 402b may be identical, or different.

Upon receipt of local meta-optimizers 402a and 402b respectively, design houses 410 and 420 may train their local meta-optimizer to compute hyper-parameters for one of their private optimization functions. As described in conjunction with FIGS. 2 and 3, a private optimization function may be tasked with finding an optimal design for a particular design task.

In some examples, the local meta-optimizers may be trained by completing one or more training sets. A training set may correspond to the performance of one or more design tasks by design house 410 and 420 respectively. As described above, a design task may be completed when an optimal design is found.

Upon completion of one or more training sets, design houses 410 and 420 may provide information associated with the training of local meta-optimizers 402a and 402b to central broker 400.

This information may include the newly trained parameters of local meta-optimizer 402a and 402b (represented as trained parameters 402a′ and 402b′ respectively). Information associated with (a) the design task(s) being targeted during the training, and (b) the performance of local meta-optimizers 402a and 402b and the private optimization functions beneath them may also be provided.

At the next step, central broker 400 may determine whether or not to update the parameters of central meta-optimizer 402 in accordance with either or both of trained parameters 402a′ and 402b′. Central broker 400 may consider a number of factors in making this determination. For example, central broker may consider (1) a design task fits the application space of central meta-optimizer 402; (2) the adequacy of training/simulations performed at design houses 410 and 420; (3) the performance of the local meta-optimizers and the private optimization functions beneath them; and (4) whether the performance of central meta-optimizer 402 has converged.

In certain examples, central broker 400 may determine to update central meta-optimizer 402 in the form of two different versions. For example, a first version of central meta-optimizer 402 may be updated in accordance with trained parameters 402a′. A second version of central meta-optimizer 402 may be updated in accordance with trained parameters 402b′. This may be the case when the design tasks being targeted by design houses 410 and 420 differed in such a way that the meta-optimization of each design task required slightly different parameterizations.

In other examples, trained parameters 402a′ and 402b′ may be merged into a single central meta-optimizer. For example, they may be merged based on a mean (or weighted mean) of parameter values.

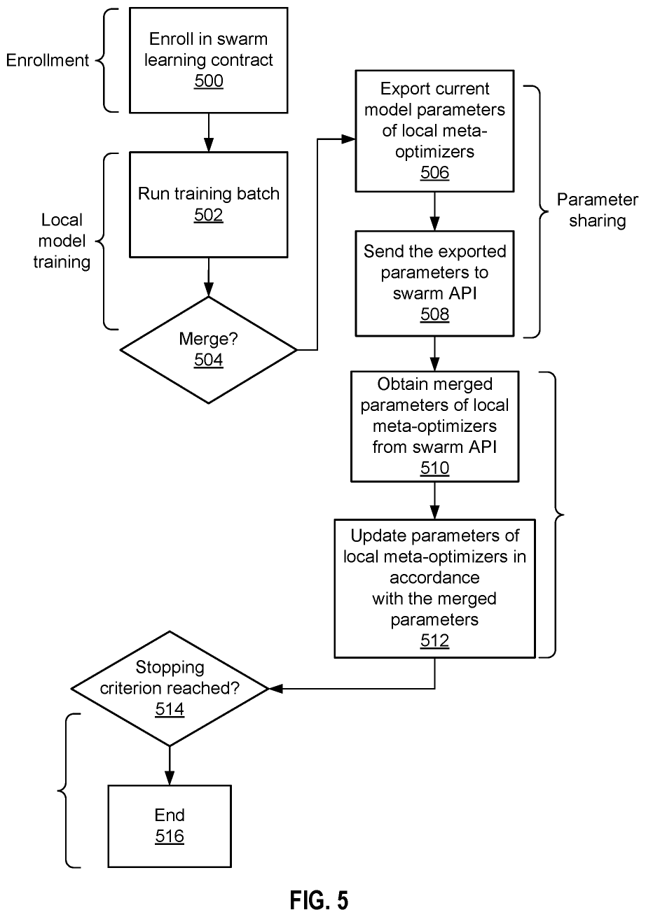

FIG. 5 illustrates a swarm learning approach by which two or more design houses may create and share knowledge, in accordance with various examples of the presently disclosed technology. Here, swarm learning is one example approach under the more general collaborative learning umbrella.

Swarm learning is a decentralized collaborative learning approach where the parameters of multiple locally trained models are merged into a “swarm model.” In certain examples, swarm learning may be implemented using blockchain technology.

Swarm learning can involve various stages or phases of operation including, but not limited to: initialization and onboarding; installation and configuration; and integration and training. Initialization and onboarding can refer to a process (that can be an offline process) that involves multiple entities interested in Swarm-based machine learning to come together and formulate the operational and legal requirements of the decentralized system. This includes aspects such as data (parameter) sharing agreements, arrangements to ensure node visibility across organizational boundaries of the entities, and a consensus on the expected outcomes from the model training process. Values of configurable parameters provided by a swarm learning network, such as the peer-discovery nodes supplied during boot up and the synchronization frequency among nodes, may be finalized at this stage. Additionally, the common (swarm) model to be trained and the reward system (if applicable) can be agreed upon.

Once the initialization and onboarding phase is complete, participants (e.g. participating design houses) may download and install a swarm learning platform/application onto their respective machines, i.e., nodes. The swarm learning platform may then boot up, and each node's connection to the swarm learning/swarm-based blockchain network can be initiated. As used herein, the term swarm learning platform can refer to a blockchain overlay on an underlying network of connections between nodes. The boot up process can be an ordered process in which the set of nodes designated as peer-discovery nodes (during the initialization phase) are booted up first, followed by the rest of the nodes in the swarm learning network.

With regard to the integration and training phase, the swarm learning platform can provide a set of application programming interfaces (APIs) that enable fast integration with multiple frameworks. These APIs can be incorporated into an existing code base for the swarm learning platform to quickly transform a stand-alone machine learning node into a swarm learning participant. Participant and node may be used interchangeably in describing various examples.

At a high level, model training in accordance with various examples may be described in terms of enrollment, local model training, parameter sharing, parameter merging, and stopping criterion check.

As described above, FIG. 5 illustrates operations that can be performed by a swarm learning platform to create and share knowledge among design houses, in accordance with various examples of the presently disclosed technology.

At 500, enrollment occurs. That is, each participating design house (i.e. node) in the swarm learning network may enroll or register itself in a swarm learning contract. In one example, this can be a one-time process. In other examples, enrollment or registration may be performed after some time as a type of verification process. A participating design house can subsequently record its relevant attributes in the swarm learning contract, e.g., the uniform resource locator (URL) from which its own set of parameters can be downloaded by other nodes.

At 502, local model training occurs. Here, each node may proceed to train a local version of a common swarm meta-optimizing model (i.e. local meta-optimizers) in an iterative fashion over multiple rounds that can be referred to as epochs. During an epoch, a node may train its local meta-optimizer using one or more data batches for some given number of iterations. As described above, this may involve training the local meta-optimizers to compute hyper-parameters for private optimization functions. These private optimization functions may be being trained to find optimal designs for particular design tasks. In certain examples, these optimal designs may correspond to global minima of costs functions, which may be found by running field simulations and performing globalization techniques such as gradient descent.

A check to determine if parameters can be merged may be performed at 504. The check can determine if a threshold number of iterations has been reached and/or whether a threshold number of nodes are ready to share their respective parameters. These thresholds can be specified during the initialization phase. After the threshold number of iterations has been reached, parameter values of the local meta-optimizers may be exported to a file, which can then be uploaded to a shared file system for other nodes to access. A node may signal the other nodes that it is ready to share its parameters.

Once parameter sharing commences, parameters of local meta-optimizers may be exported at 506 and the exported parameters can be sent to a swarm learning application programming interface (API) at 508. The parameter sharing phase can begin with the election of a merge or epoch leader, whose role is to merge the parameters derived after local training at the nodes. This election of a merge or epoch leader can occur after an epoch. While it is possible to elect a node to act as the merge leader across multiple epochs, electing a merge leader after each epoch may help ensure privacy by changing which node has the public key. Upon selection of one of the nodes of the swarm learning network to be the merge leader, the URL information of the participants or nodes can be used to download the parameter files from the nodes. In one example, a star topology can be used, where a single merge leader performs the merge. Other topologies, such as a k-way merge, where the merge is carried out by a set of nodes may also be used.

The merge leader may then merge the downloaded parameter files (from the swarm learning network nodes). Appropriate merge mechanisms or algorithms may be used, e.g., one or more of mean merging, weighted mean merging, median merging, etc. The merge leader may combine the parameter values from the nodes to create a new file with the merged parameters, and signals to the other nodes that a new file is available.

At 510, the nodes may obtain the merged parameters (represented in the new file) from the merge leader via the swarm API. At 512, the nodes may update their local meta-optimizers with the merged parameters.

At 514, a check can be performed to determine if a stopping criterion has been reached. That is, each of the nodes may evaluate their local meta-optimizers with the merged parameter values using their local training/design tasks to calculate various validation metrics. The values obtained from this operation can be shared using a smart contract state variable. As a node completes this step, it may signal to the swarm learning network that the update and validation step is complete. In the interim, the merge leader may keep checking for an update complete signal from each node. When it discovers that merge participants have signaled completion, the merge leader may merge the local validation metric numbers to calculate global metric numbers. This updating of the swarm meta-optimizing model can be thought of as a synchronization step. If the policy decided during initialization supports monetization during model building, the rewards corresponding to the contributions by the participants may be calculated and dispensed at this point. Afterwards, the current state of the swarm learning network can be compared against a stopping criterion, and if it is found to be met, the swarm learning process ends. Otherwise, the steps of local model training, parameter sharing, parameter merging, and stopping criterion check may be repeated until the criterion is fulfilled.

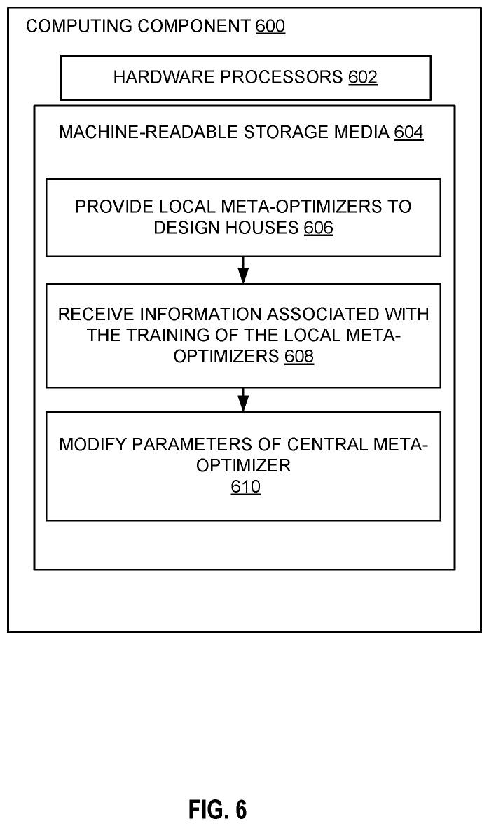

FIG. 6 illustrates an example computing component that may be used to implement a collaborative learning approach by which one or more design houses may create and share knowledge in accordance with various examples. Referring now to FIG. 6, computing component 600 may be, for example, a server computer, a controller, or any other similar computing component capable of processing data. In the example implementation of FIG. 6, the computing component 600 includes a hardware processor 602, and machine-readable storage medium for 604

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-610, to control processes or operations for burst preloading for available bandwidth estimation. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to provide a local meta-optimizer to one or more one design houses.

As described above, a local meta-optimizer is a meta-optimizer which can be a version of a central meta-optimizer (which is also a meta-optimizer). A meta-optimizer may be a computer model or algorithm (e.g. a machine learning model/algorithm) which is used/trained to improve or optimize the performance of an optimization function.

A design house (e.g. a photonics design house or an analog integrated circuit design house) may be any individual or entity which trains a private optimization function to complete design tasks. Accordingly, a private optimization function may be a computer model or algorithm (e.g. a machine learning model/algorithm) that a design house trains to complete design tasks.

A design task may be any undertaking of work that has a goal of optimizing a design (i.e. finding an optimal design). For example, a design task may involve running field simulations and performing optimization techniques (e.g. gradient descent techniques) in order to optimize a design for a device, a circuit, or a network. Accordingly, a design task may be completed when a design is optimized. In certain examples, a design task may be subject to one or more physical constraints (e.g. the limitations of a design house's foundry platform, laws of physics, etc.). In some examples, a design task may also have a desired performance goal (e.g. a certain bandwidth or insertion loss).

An optimized design may be a design geometry which achieves performance as effective or perfect as possible. However, as one of ordinary skill in the art will recognize, perfection cannot always be achieved. Accordingly, an optimized design can also encompass a design geometry which achieves performance as good or effective as possible or practical given certain physical constraints. An optimized design may also be a design geometry which achieves a desired performance goal as effective or closely as possible.

Accordingly, upon receipt of its local meta-optimizer, a design house may train its local meta-optimizer to compute hyper-parameters for a private optimization function. As described above, the private optimization function may be a machine learning model used/trained to optimize designs for particular design tasks. In some examples, optimizing a design may correspond to finding the global minimum of a cost function.

In some examples, a local meta-optimizer may be trained by completing one or more training sets. A training set may correspond to the performance of one or more design tasks by the private optimization function. As described above, each design task may be completed when a design is optimized by the private optimization function (in some cases, this will be an optimized design which achieves a desired performance goal). This may involve running thousands (or even millions) of field simulations, and performing inverse design techniques such as gradient descent or more advanced techniques.

Hardware processor 602 may execute instruction 608 to receive information associated with the training of one or more local meta-optimizers by the one or more design houses. As described in conjunction with FIG. 2, this information may comprise the parameters of one or more local meta-optimizers. These parameters may include any updates/modifications that the local meta-optimizer has made to its own parameters in response to training. Information associated with the training of one or more local meta-optimizers may also include information related to the design tasks the private optimization functions are seeking to optimize and information associated with the performance of the local meta-optimizer-private optimization function combinations.

Hardware processor 602 may execute instruction 608 to modify parameters of a central meta-optimizer. In some examples this may correspond to determining whether to modify parameters of a central meta-optimizer in accordance with the parameters of one or more local meta-optimizers.

As described in conjunction with FIG. 2, hardware processor 602 may consider any number of factors in making this determination. For example, it may consider any one or combination of: (1) whether a design task fits the application space of the central meta-optimizer; (2) the adequacy of training/simulations performed at a design house; (3) the performance of a local meta-optimizer-private optimization combination; and (4) whether the performance of the central meta-optimizer has converged. Accordingly, hardware processor 602 may make this determination in the same/similar manner as described in conjunction with FIG. 2.

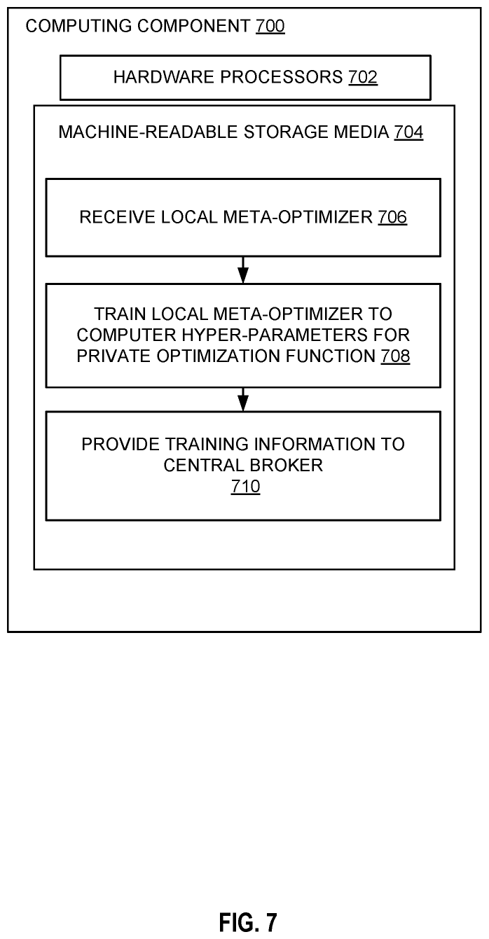

FIG. 7 illustrates an example computing component that may be used to implement a collaborative learning approach by which one or more design houses may create and share knowledge in accordance with various examples. Referring now to FIG. 7, computing component 700 may be, for example, a server computer, a controller, or any other similar computing component capable of processing data. In the example implementation of FIG. 7, the computing component 700 includes a hardware processor 702, and machine-readable storage medium for 704

Hardware processor 702 and machine-readable storage medium 704 may be the same/similar as hardware processor 602 and machine-readable storage medium 604 respectively. Accordingly, machine-readable storage medium 704 may be encoded with executable instructions, for example, instructions 706-710.

Hardware processor 702 may execute instruction 706 to receive a local meta-optimizer. This local meta-optimizer may be a version of a central meta-optimizer. The local and central meta-optimizers may be the same/similar as described in conjunction with FIGS. 2 and 6.

Hardware processor 702 may execute instruction 708 to train the local meta-optimizer to compute hyper-parameters for a private optimization function. This training may be performed in the same/similar manner as described in conjunction with FIGS. 2 and 6.

Hardware processor 702 may execute instruction 710 to provide training information to a central broker. As described above, this training information may include any one, or combination of: (1) the parameters of the local meta-optimizer; (2) information related to the design task the private optimization function was seeking to optimize; and (3) information associated with the performance of the local meta-optimizer-private optimization function combination.

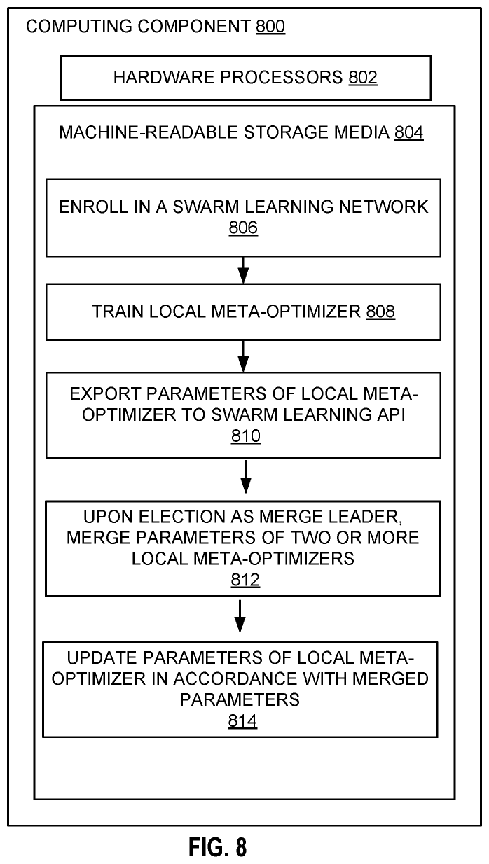

FIG. 8 illustrates an example computing component (which may be associated with a design house) that may be used to implement a swarm learning approach by which one or more design houses may create and share knowledge in accordance with various examples. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium for 804.

Hardware processor 802 and machine-readable storage medium 804 may be the same/similar as hardware processor 602 and machine-readable storage medium 604 respectively. Accordingly, machine-readable storage medium 804 may be encoded with executable instructions, for example, instructions 806-810.

Hardware processor 802 may execute instruction 806 to enroll in a swarm network. As described in conjunction with FIG. 5, hardware processor 802 may enroll in a swarm learning network by registering itself (and/or the design house it is associated with) in a swarm learning contract. In one example, this can be a one-time process. In other examples, enrollment or registration may be performed after some time as a type of verification process. Hardware processor 802 can subsequently record its relevant attributes in the swarm learning contract, e.g., the uniform resource locator (URL) from which its own set of parameters can be downloaded by other nodes.

Hardware processor 802 may execute instruction 808 to train a first local meta-optimizer to compute hyper-parameters for a private optimization function while training the private optimization function to optimize a design for a design task. As described in conjunction with FIG. 5, the first local meta-optimizer may be trained in an iterative fashion over multiple rounds that can be referred to as training epochs.

Hardware processor 802 may execute instruction 810 to export parameters of the first local meta-optimizer to a swarm learning application programming interface (API). In certain examples, this may occur upon completion of a training epoch. As described in conjunction with FIG. 5, the parameter sharing phase can begin with the election of a merge or epoch leader, whose role is to merge the parameters of local meta-optimizers derived after local training at the nodes. This election of a merge or epoch leader can occur after an training epoch. While it is possible to elect a node of the swarm learning network to act as the merge leader across multiple training epochs, electing a merge leader after each training epoch may help ensure privacy by changing which node has the public key.

Upon being elected a merge leader for the training epoch, hardware processor 802 may execute instruction 812 to merge the parameters of the first local meta-optimizer with parameters of one or more other local meta-optimizers which have been exported to the swarm learning API by one or more design houses. As described in conjunction with FIG. 5, hardware processor 802 may use the URL information of participants or nodes to download the parameter files from the nodes.

As merge leader, hardware processor 802 may merge the downloaded parameter files (from each swarm learning network node). Appropriate merge mechanisms or algorithms may be used, e.g., one or more of mean merging, weighted mean merging, median merging, etc. Hardware processor 802 may combine the parameter values from the nodes to create a new file with the merged parameters, and signal to the other nodes that a new file is available.

Hardware processor 802 may execute instruction 814 to update the parameters of the first local meta-optimizer in accordance with the merged parameters of the first local meta-optimizer and the one or more other local meta-optimizers.

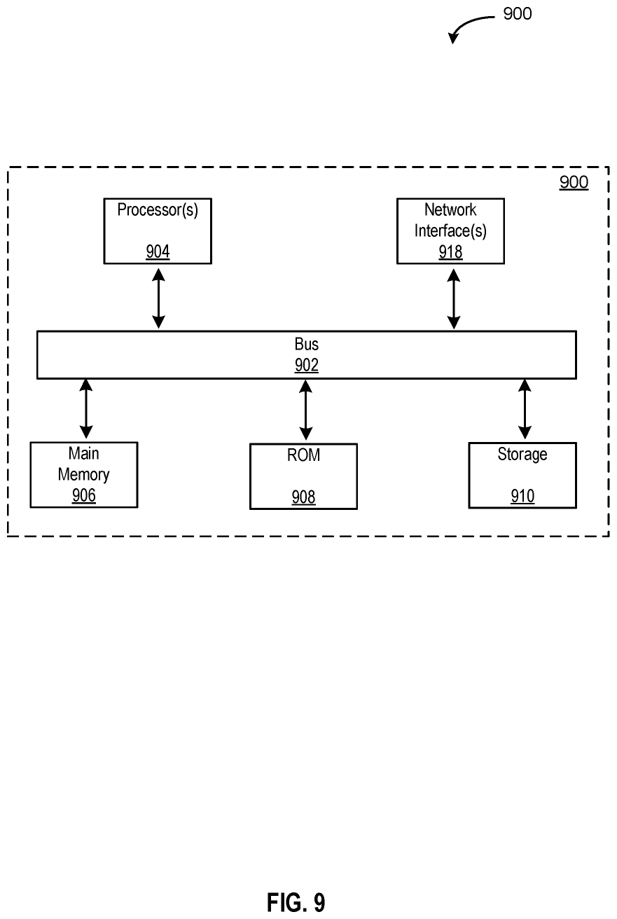

FIG. 9 depicts a block diagram of an example computer system 900 in which various of the examples described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one example, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

What is claimed is:

1. A method comprising:
receiving a local meta-optimizer;
training the local meta-optimizer to compute parameters for a private optimization function; and
providing information associated with the training of the local meta-optimizer to a central broker, wherein:
the information associated with the training of the local meta-optimizer comprises parameters of the local meta-optimizer; and
the central broker modifies parameters of the central meta-optimizer in accordance with the parameters of the local meta-optimizer.

2. The method claim 1, wherein the local meta-optimizer is a version of the central meta-optimizer.

3. The method of claim 2, further comprising, training the private optimization function to optimize a design for a design task.

4. The method of claim 3, wherein training the private optimization function to optimize the design for the design task comprises training the private optimization function to find a global minimum of a cost function.

5. The method of claim 4, wherein training the private optimization function to find the global minimum of the cost function comprises running field simulations and applying gradient descent techniques.

6. The method of claim 5, wherein training the local meta-optimizer to compute parameters for the private optimization function comprises training the local meta-optimizer to compute parameters for the private optimization function that reduce the number of field simulations required to optimize the design for the design task.

7. The method of claim 6, wherein determining whether to modify parameters of the central meta-optimizer in accordance with the parameters of the local meta-optimizer comprises:
determining whether the field simulations run by the private optimization function meet a defined standard; and
in response to the defined standard being met, modifying the parameters of the central meta-optimizer in accordance with the parameters of the local meta-optimizer.

8. The method of claim 5, wherein:
training the private optimization function to optimize the design for the design task comprises using reinforcement learning; and
determining whether to modify parameters of the central meta-optimizer in accordance with the parameters of the local meta-optimizer comprises:
in response to the private optimization function obtaining a cumulative reward which exceeds a threshold value, modifying the parameters of the central meta-optimizer in accordance with the parameters of the local meta-optimizer.

9. A system comprising:
at least one processor; and
a memory storing instructions that, when executed by the at least one processor, cause the system to perform a method comprising:
providing a local meta-optimizer to one or more design houses for training;
receiving information associated with the training of one or more local meta-optimizers by the one or more design houses, the information comprising parameters of the one or more local meta-optimizers; and
modifying parameters of the central meta-optimizer.

10. The system of claim 9, wherein modifying parameters of the central meta-optimizer comprises modifying parameters of the central meta-optimizer in accordance with the parameters of the one or more local meta-optimizers.

11. The system of claim 10, wherein modifying parameters of the central meta-optimizer in accordance with the parameters of the one or more local meta-optimizers comprises determining whether field simulations run by a given design house meet a defined standard; and
in response to the defined standard being met, modifying the parameters of the central meta-optimizer in accordance with the parameters of the local meta-optimizer which was provided to the given design house.

12. The system of claim 9, wherein the central meta-optimizer has an application space which defines the type of design tasks that the central meta-optimizer is suited to improve.

13. A non-transitory computer-readable storage medium storing a plurality of instructions executable by one or more processors, the plurality of instructions when executed by the one or more processors cause the one or more processors to:
enroll as a participant in a swarm learning network;
train a first local meta-optimizer to compute parameters for a private optimization function;
export parameters of the first local meta-optimizer to a swarm learning application programming interface (API);
in response to being elected a merge leader, merge the parameters of the first local meta-optimizer with parameters of one or more other local meta-optimizers, wherein the parameters of the one or more other local meta-optimizers have been exported to the swarm learning API by one or more other participants in the swarm learning network.

14. The computer-readable storage medium of claim 13, wherein the instructions further comprise an instruction to update the parameters of the first local meta-optimizer in accordance with the merged parameters.

15. The computer-readable storage medium of claim 13, wherein:
the swarm learning API comprises a blockchain overlay which connects participants in the swarm learning network; and
the instruction to enroll in the swarm learning network comprises an instruction to record a uniform resource locator (URL) from which the parameters of the first local meta-optimizer can be downloaded by the participants in the swarm learning network.

16. The computer-readable storage medium of claim 14, wherein the instruction to train the first local meta-optimizer to compute parameters for the private optimization function comprises an instruction to train the first local meta-optimizer to compute parameters for the private optimization function during a training epoch.

17. The computer-readable storage medium of claim 16, wherein the instruction to export parameters of the first local meta-optimizer to the swarm learning API comprises an instruction to export parameters of the first local meta-optimizer to the swarm learning API after the training epoch has been completed.

18. The computer-readable storage medium of claim 17, wherein the instruction to merge the parameters of the first local meta-optimizer with the parameters of the one or more other local meta-optimizers comprises an instruction to use a mean-merging algorithm to merge the parameters of the first local meta-optimizer with the parameters of the one or more other local meta-optimizers.

19. The computer-readable storage medium of claim 17, further comprising an instruction to create a file with the merged parameters which can be downloaded by the participants in the swarm learning network.

20. The computer-readable storage medium of claim 13, further comprising an instruction to train the private optimization function to optimize a design for a design task.
